(19) United States
(12) Patent Application Publication
(10) Pub. No.: US 2006/0098754 A1
(43) Pub. Date: May 11, 2006

(54) Beam and power allocation method for MIMO communication system

(75) Inventors: Sung-Jin Kim, Suwon-si (KR); Ye-Hoon Lee, Suwon-si (KR); Ho-Jin Kim, Seoul (KR); Kwang-Bok Lee, Seoul (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); Seoul National University Industry Foundation, Seoul (KR)

(21) Appl. No.: 11/256,251

(22) Filed: Oct. 21, 2005

Related U.S. Application Data
(60) Provisional application No. 60/620,787, filed on Oct. 21, 2004.

(51) Int. Cl. H04B 7/02

(52) U.S. Cl. 375/267

(57) ABSTRACT

A beam and power allocation method for a MIMO system transmitting multiple data streams from a transmitter having a plurality of transmit antennas to a receiver having at least two receive antennas, the transmit antennas being grouped based on feedback information from the receiver, includes obtaining covariance matrices for respective transmit antenna group, and allocating beam and power to the transmit antenna groups according to the covariance matrices of the respective antenna groups. The power allocation method can be adapted to various partial beamforming techniques by generalizing the optimization problem as a function of transmit covariance matrices.

### PRIORITY

This application claims priority under 35 U.S.C. § 119 to a provisional application entitled “HSDPA in Gaussian MIMO Broadcast Channel” filed in the United States Patent and Trademark Office on Oct. 21, 2004 and assigned Serial No. 60/620,787, the contents of which are incorporated herein by reference.

### BACKGROUND OF THE INVENTION

1. Field of the Invention

The present invention relates generally to a wireless communication system and more particularly to a beam and power allocation method for a MIMO communication system.

2. Description of the Related Art

In third generation wireless mobile communication systems (e.g. wideband code division multiple access (WCDMA)), high data rate transmissions need to be supported for wireless multimedia services. High speed downlink packet access (HSDPA) is a promising technique to achieve a bit rate of 10 Mbps. HSDPA systems employ various technologies such as adaptive modulation and coding (AMC), hybrid automatic repeat request (HARQ), fast cell selection (FCS), and multiple-input multiple-output (MIMO) antenna processing. Among them, MIMO techniques have been proven to increase spectral efficiency much higher than using other technologies. MIMO solutions for the 3rd generation partnership project (3GPP) standard have been proposed in which various multiple-antenna schemes combined with HSDPA are under active discussions.

There are various categories of MIMO schemes, depending on target performance characteristics, which increase data rate as well as spectral efficiency. Space-time coding is a popular solution for diversity gain and/or coding gain, which can be easily combined with all kinds of multiple antenna systems. Space-time block coding (STBC) has been already adopted in 3GPP standard, and is characterized by its simple transmit and receive structures for implementation. Space-time trellis coding (STTC) is another type of space-time coding, achieving diversity gain and coding gain at the cost of computational complexity. Beamforming is a good candidate for interference suppression and high capacity performance with a long history of research work, e.g., beamforming is explored in a MIMO context. Smart antennas exploit beamforming to increase system capacity and reduce interference in cellular environments. Spatial multiplexing is the most recent MIMO scheme.

Lucent developed the Bell Laboratories layered space-time (BLAST) architecture, which has two major variants, namely vertical BLAST (V-BLAST) and diagonal BLAST (DBLAST). BLAST-based schemes achieve spatial multiplexing gain by simultaneously transmitting independent data streams on different transmit branches and at the same spreading code. In V-BLAST, independent channel coding is applied to each sub-layer, i.e., different data substreams are mapped to each transmit antenna. Most of the previous MIMO schemes are designed for point-to-point communications, which is referred to as single-user MIMO (SU-MIMO). For the evaluation of system performance, a multi-user environment needs to be considered, whereas SU-MIMO systems focus on link performance without any higher layer assumptions. In multi-user MIMO (MU-MIMO) systems, priority scheduling is applied for downlink transmission to serve multiple mobile stations (MSs) so that for performance evaluation the system-wise comparison is more preferable than merely the link-wise comparison.

In performance evaluation of MIMO, a singular value decomposition (SVD)-based MIMO scheme is the optimal solution by exploiting water-filling (WF) in subchannels with perfect channel state information (CSI) at both the transmitter and receiver.

However, the SVD-based closed-loop MIMO scheme requires so much feedback information and computational complexity. In order to accomplish performance close to the SVD-based full beamforming scheme with partial CSI feedback, partial beamforming techniques such as double transmit antenna array (D-TxAA) have been proposed.

D-TxAA is a MIMO scheme for sending multiple data streams with spatial multiplexing. In D-TxAA, if four transmit antennas are employed in the base station, transmit antennas are divided into two groups and each group transmits an independent data stream with TxAA operation of a pair of transmit antennas. TxAA is a diversity scheme adopted in WCDMA system. The data rate of each group can be controlled independently.

However, D-TxAA has been optimized only for a 4Tx antenna and a 2Rx antenna system, resulting in limitations in adapting various other MIMO systems.

### SUMMARY OF THE INVENTION

The present invention has been made in an effort to solve the above and other problems occurring in the prior art, and it is an object of the present invention to provide a beam and power allocation method which is capable of allocating power to multiple antennas in an optimal manner in a Gaussian MIMO broadcast channel (BC).

It is another object of the present invention to provide a beam and power allocation method which is capable of maximizing a sum rate capability of a transmitter.

It is still another object of the present invention to provide a beam and power allocation method capable of optimally allocating power to multiple antennas with a low feedback amount and minimal computational complexity.

In order to accomplish the above and other objects, there is provided a beam and power allocation method for a MIMO system transmitting multiple data streams from a transmitter having a plurality of transmit antennas to a receiver having at least two receive antennas, the transmit antennas being grouped based on feedback information from the receiver. In one aspect of the present invention, the method includes obtaining covariance matrices for each transmit antenna group, and allocating beam and power to the transmit antenna groups according to the covariance matrices of the respective antenna groups. The covariance matrices are calculated at the receiver and fed back to the transmitter.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating a partial beamforming MIMO system adapting a beam and power allocation method according to one embodiment of the present invention.

### DETAILED DESCRIPTION OF THE PREFERRED EMBODIMENTS

Preferred embodiments of the present invention will be described in detail hereinafter with reference to the accompanying drawings. In the following description of the present invention, a detailed description of known functions and configurations incorporated herein will be omitted when it may obscure the subject matter of the present invention.

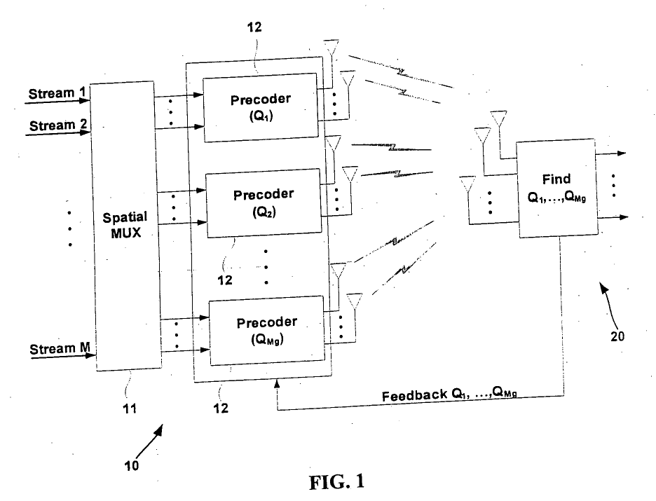

FIG. 1 is a block diagram of MIMO system adapting the power allocation method of the present invention.

As shown in FIG. 1, the MIMO system includes a base station 10 having N transmit antennas and a mobile terminal 20 having M receive antennas. The transmitter 10 includes a spatial multiplexer 11 which spatially multiplexes M input streams and outputs grouped streams and M_{g} precoders 12 each of which performs precoding of respective streams groups and then transmits the precoded streams. The mobile terminal 20 receives signals through at least two receive antennas and estimates the channels and generates covariance matrices of the antenna groups. The covariance matrices are fed back to the transmitter such that the base station 10 allocates beams of the respective groups and allocates power to the transmit antennas.

In the present invention, the similarity between the multi-antenna transmission and the multi-user access is used to solve the optimal power allocation problem.

For a partial beamforming scheme, a multi-user MIMO system is used to find its capacity and power allocation policy. Mathematically, if the partial beamforming system has Mₜ transmit antennas, Mᵣ receive antennas, and M_{g} antenna groups, then it is equivalent to the multi-user MIMO system consisting of a base station with Mᵣ transmit antennas and M_{g} mobile stations each with Mₜ/M_{g} receive antennas. In other words, the system can be reversely shown to be such that the mobile stations become a single base station having Mᵣ transmit antennas and the antenna groups of the base station become mobile stations each having Mₜ/M_{g} receive antennas.

In order to prove the similarity, it is required to show that the achievable throughput of the single-user MIMO system with a partial beamforming such as DTxAA is equivalently represented as the sum-rate capacity of the corresponding Gaussian MIMO BC, which is given by Equation 1:

$${C}_{BC} ( {H}_{1}^{H} , {H}_{2}^{H} ) = {max}_{\{ {\sum }_{m} \}} log \vert I + {H}_{1}^{H} {\sum }_{1} {H}_{1} \vert + log \frac{\vert I + {H}_{2}^{H} ( {\sum }_{1} + {\sum }_{2} ) {H}_{2} \vert}{\vert I + {H}_{2}^{H} {\sum }_{1} {H}_{2} \vert} , \\ subject to {\sum }_{m} \geq 0 , {\sum }_{m = 1}^{2} Tr ( {\sum }_{m} ) \leq P \qquad ( 1 )$$

where H is a channel matrix, ^{H} is the Hermitian operator, I is identical matrix, Σₘ is downlink covariance matrix of m^{th} group, and P is total power and Tᵣ is the trace of a matrix. In linear algebra, the trace of an n-by-n square matrix A is defined to be the sum of the elements on the main diagonal (the diagonal from the upper left to the lower right) of A.

The original formula representing the capacity of DTxAA is expressed by Equation 2:

$$\begin{matrix}{C}_{DTxAA} ( H ) = {max}_{Q : Q \geq 0 , Tr ( Q ) < P} log \vert I + H Q {H}^{H} \vert \\ = {max}_{{Q}_{m}} log \vert I + {H}_{1} {Q}_{1} {H}_{1}^{H} + {H}_{2} {Q}_{2} {H}_{2}^{H} \vert\end{matrix} \qquad ( 2 )$$

where Q=diag(Q₁, Q₂) and H=[H₁, H₂]. Using the duality of the BC and the MAC Equation 2 can be rewritten as Equation 3:

$${C}_{DTxAA} ( {H}_{1} {H}_{2} ) = {max}_{\{ {Q}_{m} \}} log \vert I + {\sum }_{m = 1}^{2} {H}_{m} {Q}_{m} {H}_{m}^{H} \vert , \\ subject to {Q}_{m} \geq 0 , {\sum }_{m = 1}^{2} Tr ( {Q}_{m} ) \leq P \qquad ( 3 )$$

where H₁=[h₁,h₂] and H₂=[h₃, h₄] denote the first and second group channel matrices, respectively, and Qₘ is the transmit covariance matrix of m^{th} antenna group.

The optimization is performed based on the iterative water-filling or subset property. In the special case, i.e., Mₜ=4 in SU-MIMO, iterative water-filling with the sum power constraint leads to the maximum throughput.

The optimal transmit covariance matrices for partial beamforming can be found using iterative water filling (WF) which has been shown as an effective optimization tool to design the transmit covariance for the downlink MU-MIMO system.

The sum-power iterative WF is used to solve multi-user problems. For simplicity, it is assumed that Mₜ=Mᵣ=4, and M_{g}=2. The sum-power iterative WF algorithm is described as follows:

1) Initialize each covariance matrix Qᵢ by water-filling over Hᵢ with total power P/M_{g} for i=1, 2.

2) Generate effective channels as Equation 4:

$${G}_{i}^{( m )} = {( I + {\sum }_{j \neq i} {H}_{j} {Q}_{j}^{m - 1} {H}_{j}^{H} )}^{- 1 / 2} {H}_{i} \\ for i = 1 , 2. \qquad ( 4 )$$

3) Obtain the new covariance matrices {Qⱼ^{(m-1)}}ᵢ₌₁² by water-filling over Gᵢ^{(m)} with total power P as Equation 5, treating the effective channels as parallel channels.
Qᵢ^{(m)}=VᵢΛᵢVᵢ^{H} (5)

where Gᵢ^{(m)H}Gᵢ^{(m)}=VᵢDᵢVᵢ^{H} by SVD and Vᵢ=[μI−(Dᵢ)⁻¹]⁺. The operation [A]+denotes a component-wise maximum with zero, and the water-filling level μ is chosen such that Σᵢ₌₁²=Tr(Σᵢ)=P.

Note that as shown in Equation 5, the covariance matrix Qᵢ^{(m)} consists of the beamforming matrix Vᵢ and the diagonal power matrix Σᵢ.

As described above, the power allocation method of the present invention can optimally allocate power to the multiple antennas with a low feedback amount and minimal computational complexity using the partial beamforming technique.

Also, the power allocation method of the present invention can obtain performance close to the SVD-based full beamforming scheme with partial CSI feedback, by maximizing the sum rate capability of the transmitter using the similarity between the multiple antenna system and multi-user channel problems, which enables iterative water-filling.

Also, the power allocation method of the present invention can be adapted to various partial beamforming techniques by generalizing the optimization problem as a function of transmit covariance matrices.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A beam and power allocation method for a MIMO system transmitting multiple data streams from a transmitter having a plurality of transmit antennas to a receiver having at least two receive antennas, the transmit antennas being grouped based on feedback information from the receiver, comprising:
obtaining precoding information for each transmit antenna group; and
allocating beam and power to the transmit antenna groups according to the precoding information of the respective antenna groups.

2. The method of claim 1, wherein the precoding information is covariance matrices of the respective groups fed back from the receiver.

3. The method of claim 2, wherein the covariance matrices are determined using iterative water-filling with sum power constraint of the transmitter.

4. The method of claim 2, wherein the step of obtaining preceding information includes determining, iteratively, covariance matrices of the respective groups.

5. The method of claim 2, wherein each covariance matrix is provided with a beamforming matrix and a diagonal power matrix.

6. The method of claim 2, wherein the groups transmit data streams different from each other.

7. The method of claim 6, wherein the transmit antennas of each group transmit identical data streams correlated with each other.

8. A power allocation method for a MIMO system transmitting multiple data streams from a transmitter having a plurality of transmit antennas to a receiver having at least two receive antennas, the transmit antennas being grouped based on feedback information from the receiver, comprising:
obtaining covariance matrices for the transmit antennas using iterative water-filling with sum power constraint;
allocating power to the transmit antennas based on the covariance matrices.

9. The method of claim 8, wherein each covariance matrix is provided with a beamforming matrix and a diagonal power matrix.

10. The method of claim 8, wherein the groups transmit data streams different from each other.

11. The method of claim 10, wherein the transmit antennas of each group transmit identical data streams correlated with each other.
